(19) United States
(12) Patent Application Publication
(10) Pub. No.: US 2024/0047145 A1
(43) Pub. Date: Feb. 8, 2024

(54) A CELL FOR GENERATING ELECTRICAL ENERGY FROM ATMOSPHERIC HUMIDITY AND A METHOD USED FOR OBTAINING CELL

(71) Applicant: HACETTEPE UNIVERSITESI REKTORLUK, Cankaya/Ankara (TR)

(72) Inventors: Soheil MALEKGHASEMI, Ankara (TR); Serdar ABACI, Ankara (TR)

(73) Assignee: HACETTEPE UNIVERSITESI REKTORLUK, Cankaya/Ankara (TR)

(21) Appl. No.: 18/546,532

(22) PCT Filed: Feb. 16, 2022
(86) PCT No.: PCT/TR2022/050134

§ 371 Date: Aug. 15, 2023

(30) Foreign Application Priority Data
Feb. 16, 2021 (TR) 2021/002152

(51) Int. Cl. H01G 11/04; H01G 11/02; H01G 11/36; H01G 11/84

(52) U.S. Cl. CPC H01G 11/04; H01G 11/02; H01G 11/36; H01G 11/84

(57) ABSTRACT

The present invention relates to a hybrid vapovoltaic/supercapacitor cell which enables to generate and store electrical energy without using any condensation process by means of catalytic oxidation from atmospheric humidity, and a method for obtaining the said cell.

### TECHNICAL FIELD

The present invention relates to a hybrid vapovoltaic/supercapacitor cell which enables to generate and store electrical energy without using any condensation process by means of catalytic oxidation from atmospheric humidity, and a method for obtaining the said cell.

### BACKGROUND OF THE INVENTION

Today, three main types of energy are available to generate electrical energy. These are fossil fuels such as coal, natural gas and oil; nuclear energy and renewable energy sources. Most of the electricity is generated by means of steam turbines, nuclear, biomass, geothermal and solar energy by using fossil fuels. However, fossil fuels lead to global warming and they are types of fuels which are non-renewable, unsustainable and dangerous to generate. Nuclear energy applications require use of too much water in order to generate energy and they lead to the risk of nuclear accident and production of toxic radioactive waste. In addition, it is non-renewable energy source. On the other hand, difficulties are experienced with respect to power generation in large amounts in renewable energy technology; it is completely dependent on weather conditions (for example, sun and wind) in order to utilize any energy; too much space (space requirement of more than 40 hectares in order to generate 20 megawatts of solar energy) is required for installation of power generation plants; a storage cost exists due to use of batteries in order that the gathered renewable energy is not lost and distribution networks are required to transfer the renewable energy where needed; and it is required to use non-renewable energies to sustain these networks.

Therefore, there is need for a power generation cell or a vapovoltaic (a device that absorbs the atmospheric humidity and generates electric current) which does not emit any toxic chemical and/or gas (CO₂ or greenhouse gas) to the environment in generation of energy, has an entirely environment-friendly production method, does not depend on any weather condition for generation of energy, needs and stores a small space for production; and a method for obtaining this cell.

The Japanese patent document no. JP2004135366A, an application in the state of the an, discloses a power generation device using the moisture in the atmosphere. The device uses the electricity obtained by the hybrid power generation by making use of natural energy such as wind energy, solar energy and atmospheric humidity. The pure water generated by using the raw water generated is electrolyzed, the high-purity hydrogen gas and the oxygen gas obtained by electrolyzing are used for generating electricity by means of a fuel cell and the electricity generated by hybrid power generation is stored in a power storage device. In addition, a fuel cell is needed in order to generate electricity. A fuel cell comprises solid polymer electrode and the water obtain from the moisture in the atmosphere is separated into its ions by means of catalyst layers of the electrode.

### SUMMARY OF THE INVENTION

An objective of the present invention is to realize hybrid vapovoltaic/supercapacitor cells which enable to generate and store electrical energy without using any condensation process and solar radiation by means of catalytic oxidation from atmospheric humidity, and a method for obtaining these cells.

Another objective of the present invention is to realize hybrid vapovoltaic/supercapacitor cells which do not emit any toxic chemical and/or gas (CO₂ or greenhouse gas) to the environment in generation of energy, and a method for obtaining these cells.

Another objective of the present invention is to realize hybrid vapovoltaic/supercapacitor cells which do not depend on any weather condition for generation of energy, and a method for obtaining these cells.

Another objective of the present invention is to realize hybrid vapovoltaic/supercapacitor cells which require a small space for production and generate storable energy, and a method for obtaining these cells.

### DETAILED DESCRIPTION OF THE INVENTION

“A Cell for Generating Electrical Energy from Atmospheric Humidity and A Method used for Obtaining Cell” realized to fulfil the objectives of the present invention is shown in the figures attached, in which:

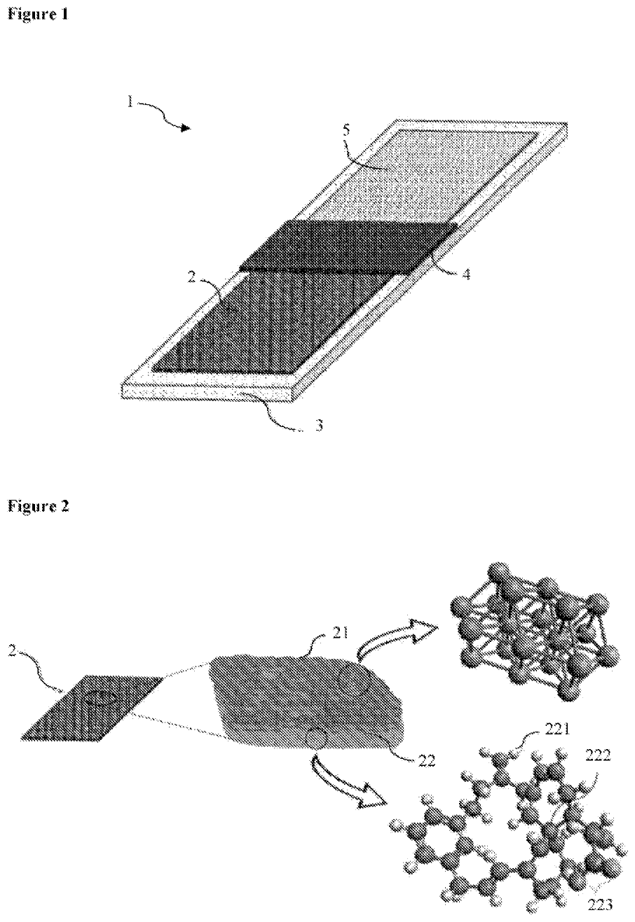

FIG. 1 is an overall view of the inventive vapovoltaic cell.

FIG. 2 is a view of a hybrid electrode in the inventive vapovoltaic cell.

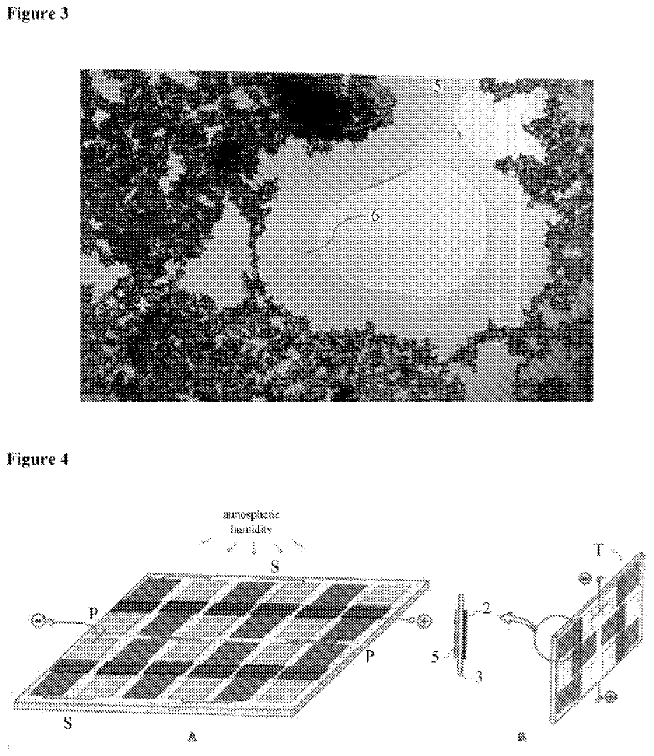

FIG. 3 is a view of structures in the inventive hybrid electrode.

FIG. 4A. shows the conditions of the inventive cells wherein they are connected in parallel and in series.

FIG. 4B. shows the conditions of hybrid electrodes wherein they are attached to both faces of the filter paper.

FIG. 5A. shows the voltage properties of hybrid electrodes diagrammatically at a constant humidity rate of 55% and at room temperature.

FIG. 5B. shows the change of voltage generated by the cell according to the humidity rate diagrammatically.

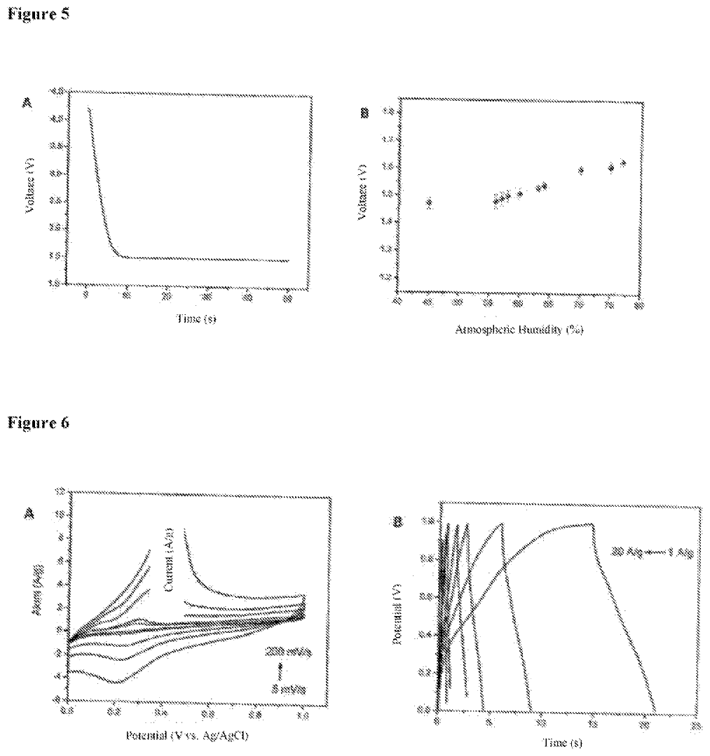

FIG. 6A. shows a series of CV measurements of an asymmetric cell at different scanning rates between 5 to 200 mV/s.

FIG. 6B. shows the galvanostatic curve, which is gathered for the cell, for various charge/discharge current densities by less IR drop.

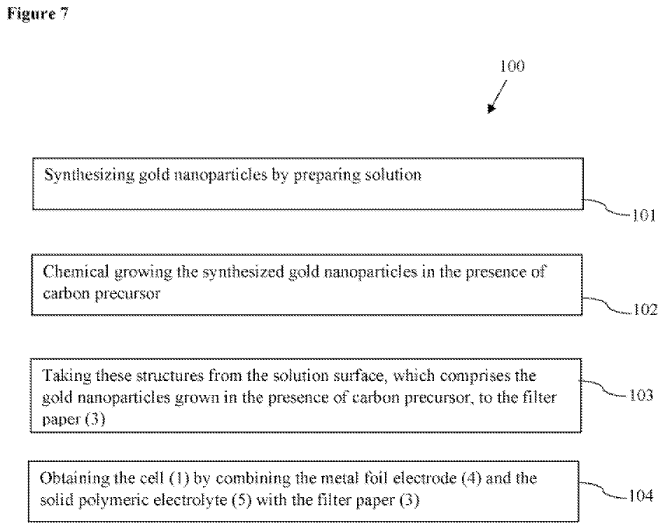

FIG. 7. shows the flowchart of the inventive method.

The components illustrated in the figures are individually numbered, where the numbers refer to the following:
1. Vapovoltaic/supercapacitor cell
2. Hybrid electrode
21. Gold nanocrystal network
22. Carbon nanofilm
221. sp² carbon content
222. sp³ carbon content
223. Functional group comprising surface oxygen
3. Filter paper
4. Metal foil electrode
5. Solid polymeric electrolyte

100. Method

The inventive vapovoltaic/supercapacitor cell (1) which enables to generate and store electrical energy by means of catalytic oxidation from atmospheric humidity comprises.
at least one hybrid electrode (2) which has a double-layer structure created by interconnection of conductive gold nanocrystal networks (21) and diamond-like carbon nanofilms (22), and generates hybrid film by converting atmospheric water vapor (atmospheric humidity) oxidation into dioxygen with high electron current densities;
at least one filter paper (3) that provides a surface on which produced hybrid films can adhere to the hybrid electrode (2);
at least one metal foil electrode (4) which is located on the filter paper (3) and comprises at least electrically conductive current collector member; and
at least one solid polymeric electrolyte (5) which is located on the filter paper (3) and enables movement of at least one ion from cathode to anode.

The hybrid electrode (2) included in the inventive cell (1) has a diamond-like carbon nanofilm (22) containing more sp³ (222) carbon content than sp² (221) and functional groups containing surface oxygen (223). In addition, the gold nanocrystal network (21) of the hybrid electrode (2) enables fastening to the graphitic material surface by means of carbon-gold interactions. The hybrid electrode (2) turns atmospheric water vapor oxidation into dioxygen by means of current densities

The filter paper (3) included in the inventive cell (1) may have a planar surface, at least one of vertical/horizontal cylindrical or any hollow shape. The filter paper (3) has a flexible and porous structure in order to facilitate adhesion of hybrid films.

The inventive method (100) for obtaining cells (1) which used for generating electrical energy from atmospheric humidity comprises steps of.
synthesizing gold nanoparticles by preparing solution (101);
chemical growing the synthesized gold nanoparticles in the presence of carbon precursor (102);
taking these structures from the solution surface, which comprises the gold nanoparticles grown in the presence of carbon precursor, to the filter paper (3)(103),
obtaining the cell (1) by combining the metal foil electrode (4) and the solid polymeric electrolyte (5) with the filter paper (3)(104).

At the step of obtaining gold nanoparticles by preparing solution (101) of the inventive method (100), a chloroauric acid solution of 10.5-13.5 mM is prepared by deionized ultra-filtered 140. The container wherein the solution is included is placed onto a heating plate and then the condenser is attached. The solution is heated under constant stirring until it reaches the boiling point. Then, a trisodium citrate solution of 36.5-39.5 mM is added into the solution and immediately after the adding process, the solution colour turns into blue within the first 20-70 seconds and then into red within 100-200 seconds Change of colour occurs due to the fact that the size of gold nanoparticles change upon the citrate ions reduce the gold (III) during the synthesis takin place within the solution. The boiling process is continued for 3-10 minutes and then the solution is cooled at room temperature. A centrifugation process is carried out in order to remove the unreacted trisodium citrates from the solution and then it is stored in a cold and dark environment.

At the step of chemical growing the synthesized gold nanoparticles in the presence of carbon precursor (102) of the inventive method (100), the synthesized and stored gold nanoparticle solution (0.001-0.01 g) is treated at 55-95° C. for 10-40 minutes with 0.01-0.1 g hydroxylamine hydrochloride on a heating magnetic stirrer. Under these conditions, diamond-like carbon structures are created by interconnecting the conductive gold nanocrystal network structure and the citrate bound parts through the use of Au²⁺ and Au¹⁺ ions acting as a catalyst in the solution, by sintering the gold nanoparticle parts of the citrate-capped gold nanoparticles.

At the step of taking these structures from the solution surface, which comprises the gold nanoparticles grown in the presence of carbon precursor, to the filter paper (3) (103) of the inventive method (100), the film layer (hybrid electrode (2)) comprising the double-layer gold nanoparticle and the diamond-like carbon structures located on the solution surface are contacted with the filter paper (3) and the film layer on the said solution surface is coated onto the porous surface of the filter paper (3).

At the step of obtaining the cell (1) by combining the metal foil electrode (4) and the solid polymeric electrolyte (5) with the filter paper (3) (104) of the inventive method (100), the cells which are obtained upon being combined with the filter paper (3) coated with the hybrid electrode (2), the metal foil electrode (4) and the solid polymeric electrolyte (5) are used for generating electrical energy from atmospheric humidity, upon being connected individually, in series, parallel or double-sided to each other.

The FIG. 3 shows the formation of gold nanocrystal networks (21) for the cell (1) obtained by means of the inventive method (100), upon the black network or cloud-like structures of the hybrid electrode (2) are fused together and grown. In addition, formation of diamond-like structures (22) are observed in the lower part of the nanocrystal networks (21) The FIG. 4A shows that the cells (1) can be integrated in parallel (P) and in series (S) in order to increase the output currents, voltages and powers of cells. And the FIG. 4B shows a form of energy harvest (T) wherein the hybrid electrodes (2) can be attached from both sides of the filter paper (3). This structure takes up less space in comparison to structures which are created so as to be connected in series and in parallel to create the same current and voltage. The Figure SA shows the voltage properties of the related hybrid electrodes (2) diagrammatically at a constant humidity rate of 55% and at room temperature. 4.2 V is generated and stored by means of the cell (1) prepared under these conditions. Then, the voltage of the cell (1) is reduced to 1.5 V upon the cell (1) is connected to a consumer such as LED and it is continued to generate electricity steadily by means of operation of the hybrid electrodes (2). The FIG. 5B shows the change of voltage generated by the cell (1), which provides generation of energy, according to the humidity rate diagrammatically. In the said diagram, the amount of the generated voltage increases as the ambient humidity increases as well. Measurements of cyclic voltammetry (CV) and galvanostatic charge-discharge (GCD) are used in order to evaluate the electrochemical performance of the cell (1). The FIG. 6A shows a series of CV measurements of an asymmetric cell (1) at different scanning rates between 5 to 200 mV/s. A specific capacitance of maximum 15 F/g is obtained at a scanning rate of 200 mV/s for only one cell (1) (5×10 mm). The galvanostatic curve, which is gathered for the cell, is shown in the FIG. 6B for various charge/discharge current densities by less IR drop.

The inventive cell (1) uses the atmospheric humidity as reactant and it releases the energy in the form of a direct current (DC) electricity and then stores it, by generating dioxygen as a by-product via oxidation of catalytic water vapour to the hybrid electrode (2). The humidity of the atmosphere or the environment used for generating electrical energy by the said cell (1) is a renewable and sustainable energy source. Therefore, it has an entirely environment-friendly production which does not emit any toxic chemical and/or gas (for example, CO₂ and greenhouse gas) to the environment. Also, the cell (1) has a structure with a capability to generate energy for 24 hours a day and does not depend on any weather condition (for example, sun and wind). The generated cells (1) can generate energy in a small space by taking up less space in comparison to solar panels. The generated cells (1) generate energy according to the humidity rate in the air and they can generate energy more productively and with high performance in areas (atmospheres close to warm sea water) with higher humidity rate. It is not needed to be localized to certain areas in order to construct production plants. It is facilitated to store the generated energy due to the capacitor characteristic of the cells (1).

Within these basic concepts, it is possible to develop various embodiments of the inventive “Cell (1) for Generating Electrical Energy from Atmospheric Humidity and A Method (100) used for Obtaining Cell (1)”; the invention cannot be limited to examples disclosed herein and it is essentially according to claims.

1. A vapovoltaic/supercapacitor cell (1) which enables to generate and store electrical energy by means of catalytic oxidation from atmospheric humidity; characterized by
at least one hybrid electrode (2) which has a double-layer structure created by interconnection of conductive gold nanocrystal networks (21) and diamond-like carbon nanofilms (22), and generates hybrid film by converting atmospheric water vapor (atmospheric humidity) oxidation into dioxygen by means of high electron current densities;
at least one filter paper (3) that provides a surface on which produced hybrid films can adhere to hybrid electrode (2); at least one metal foil electrode (4) which is located on the filter paper (3) and comprises at least electrically conductive current collector member; and
at least one solid polymeric electrolyte (5) which is located on the filter paper (3) and enables movement of at least one ion from cathode to anode.

2. A cell (1) according to claim 1; characterized by the hybrid electrode (2) has a diamond-like carbon nanofilm (22) containing more sp³ (222) carbon content than sp² (221) and functional groups containing surface oxygen (223).

3. A cell (1) according to claim 1, characterized by the hybrid electrode (2) which enables fastening to the graphitic material surface by means of carbon-gold interactions with the gold nanocrystal network (21).

4. A cell (1) according to claim 1, characterized by the filter paper (3) which may have a planar surface, at least one of vertical/horizontal cylindrical or any hollow shape.

5. A cell (1) according to claim 1, characterized by the filter paper (3) which has a flexible and porous structure in order to facilitate adhesion of hybrid films.

6. A method (100) for obtaining a cell (1) according to claim 1, which is used for generating electrical energy from atmospheric humidity; characterized in that steps of:
synthesizing gold nanoparticles by preparing solution (101);
chemical growing the synthesized gold nanoparticles in the presence of carbon precursor (102);
taking these structures from the solution surface, which comprises the gold nanoparticles grown in the presence of carbon precursor, to the filter paper (3) (103);
obtaining the cell (1) by combining the metal foil electrode (4) and the solid polymeric electrolyte (5) with the filter paper (3) (104) are followed.

7. A method (100) according to claim 6; characterized in that a chloroauric acid solution of 10.5-13.5 mM is prepared by deionized ultra-filtered H2O, at the step of obtaining gold nanoparticles by preparing solution (101).

8. A method (100) according to claim 7; characterized in that the container wherein the solution is included is placed onto a heating plate and then the condenser is attached.

9. A method (100) according to claim 8; characterized in that the solution is heated under constant stirring until it reaches the boiling point.

10. A method (100) according to claim 9; characterized in that a trisodium citrate solution of 36.5-39.5 mM is added into the solution and immediately after the adding process, the solution colour turns into blue within the first 20-70 seconds and then into red within 100-200 seconds.

11. A method (100) according to claim 10; characterized in that change of colour occurs due to the fact that the size of gold nanoparticles change upon the citrate ions reduce the gold (III) during the synthesis takin place within the solution.

12. A method (100) according to claim 10, characterized in that the boiling process is continued for 3-10 minutes and then the solution is cooled at room temperature.

13. A method (100) according to claim 12; characterized in that a centrifugation process is carried out in order to remove the unreacted trisodium citrates from the solution and then it is stored in a cold and dark environment.

14. A method (100) according to claim 6, characterized in that the synthesized and stored gold nanoparticle solution (0.001-0.01 g) is treated at 55-95° C. for 10-40 minutes with 0.01-0.1 g hydroxylamine hydrochloride on a heating magnetic stirrer, at the step of growing the synthesized gold nanoparticles in the presence of carbon precursor chemically (102).

15. A method (100) according to claim 14; characterized in that diamond like carbon structures are created by interconnecting the conductive gold nanocrystal network structure and the citrate bound parts through the use of Au2+ and Au1+ ions acting as a catalyst in the solution, by sintering the gold nanoparticle parts of the citrate-capped gold nanoparticles under these conditions.

16. A method (100) according to claim 6, characterized in that the film layer (hybrid electrode (2)) comprising the double-layer gold nanoparticle and the diamond-like carbon structures located on the solution surface are contacted with the filter paper (3) and the film layer on the said solution surface is coated onto the porous surface of the filter paper (3) from the solution surface, at the step of taking these structures—which comprises the gold nanoparticles grown in the presence of carbon precursor—to the filter paper (3) (103).

17. A method (100) according to claim 6, characterized characterized in that the cells which are obtained upon being combined with the filter paper (3) coated with the hybrid electrode (2), the metal foil electrode (4) and the solid polymeric electrolyte (5) are used for generating electrical energy from atmospheric humidity, upon being connected individually, in series, parallel or double-sided to each other, at the step of obtaining the cell (1) by combining the metal foil electrode (4) and the solid polymeric electrolyte (5) with the filter paper (3) (104).
